(19) United States
(12) Patent Application Publication
(10) Pub. No.: US 2011/0047984 A1
(43) Pub. Date: Mar. 3, 2011

(54) EXHAUST SYSTEM

(75) Inventors: Jin Ha Lee, Seoul (KR); Jin Woo Park, Suwon-city (KR); Jun Sung Park, Yongin-city (KR)

(73) Assignees: HYUNDAI MOTOR COMPANY, Seoul (KR); KIA MOTORS CORPORATION, Seoul (KR)

(21) Appl. No.: 12/621,263

(22) Filed: Nov. 18, 2009

(30) Foreign Application Priority Data
Aug. 31, 2009 (KR) 10-2009-0081574

(51) Int. Cl. F01N 3/20; B01D 53/94; B01D 53/90

(52) U.S. Cl. 60/286; 422/178; 422/105

(57) ABSTRACT

An exhaust system, may include an exhaust line through which exhaust gas passes, a nitrogen oxide purification catalyst that is mounted on the exhaust line to reduce nitrogen oxide of the exhaust gas, an injector that is mounted at an upstream side of the nitrogen oxide purification catalyst to additionally inject fuel such that nitrogen oxide that is trapped in the nitrogen oxide purification catalyst is detached to be reduced thereby, and a control portion that varies an injection pattern of the injector if it is determined that a purification rate of the nitrogen oxide purification catalyst is higher than a first predetermined value.

### CROSS-REFERENCE TO RELATED APPLICATION

The present application claims priority to Korean Patent Application No. 10-2009-0081574 filed on Aug. 31, 2009, the entire contents of which are incorporated herein for all purposes by this reference.

### BACKGROUND OF THE INVENTION

1. Field of the Invention

The present invention relates to an exhaust system. More particularly, the present invention relates to an exhaust system for reducing nitrogen oxide that is included in exhaust gas.

2. Description of Related Art

Generally, exhaust gas that is exhausted through an exhaust manifold of an engine is induced to pass through a catalytic converter that is mounted in the middle of an exhaust pipe to be purified, and noise thereof is reduced while passing through a muffler before the exhaust gas is discharged to the outside through a tail pipe.

The catalytic converter processes the pollution materials that are included in the exhaust gas. Further, a particulate filter is mounted on the exhaust pipe to trap particulate material (PM) that is included in the exhaust gas.

A selective catalytic reduction device is a type of catalytic converter. Reducing agents such as carbon monoxide, total hydrocarbon (THC), and so on react well with nitrogen oxide rather than oxygen in the selective catalyst reduction apparatus (SCR), which is why it is called a selective catalyst reduction apparatus (SCR).

In an internal combustion engine to which the selective catalyst reduction apparatus is installed, the fuel is continuously and additionally injected according to the nitrogen oxide amount in the exhaust gas. Accordingly, the hydrocarbon can be slipped from the selective catalyst reduction apparatus, and the fuel consumption is increased.

Also, when the reducing agent is continuously supplied, an oxidation/reduction reaction is also continuously performed in the exhaust pipe. Accordingly, the durability of the catalyst is deteriorated by reaction heat that is formed during the oxidation/reduction reaction.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an exhaust system having advantages of improving regeneration efficiency according to the deterioration rate of the catalyst.

In an aspect of the present invention, the exhaust system, may include an exhaust line through which exhaust gas passes, a nitrogen oxide purification catalyst that is mounted on the exhaust line to reduce nitrogen oxide of the exhaust gas, an injector that is mounted at an upstream side of the nitrogen oxide purification catalyst to additionally inject fuel such that nitrogen oxide that is trapped in the nitrogen oxide purification catalyst is detached to be reduced thereby, and a control portion that varies an injection pattern of the injector if it is determined that a purification rate of the nitrogen oxide purification catalyst is higher than a first predetermined value.

The control portion may use a temperature difference between front side and rear side of the nitrogen oxide purification catalyst to detect the purification rate of the nitrogen oxide purification catalyst after the fuel is additionally injected by the injector, and varies the injection pattern of the injector in a case in which the temperature difference thereof is lower than a second predetermined value, wherein the control portion uses an oxygen concentration difference between the front side and the rear side of the nitrogen oxide purification catalyst to detect the purification rate of the nitrogen oxide purification catalyst after the fuel is additionally injected by the injector, and varies the injection pattern of the injector in a case in which the oxygen concentration difference thereof is higher than a third predetermined value.

After it is determined that the nitrogen oxide purification catalyst is deteriorated, the control portion may vary the injection pattern of the injector at the next injection and wherein the deterioration of the nitrogen oxide purification catalyst is concluded in a case that the temperature difference between the front side and the rear side of the nitrogen oxide purification catalyst is lower than the second predetermined value and the oxygen concentration difference between the front side and the rear side of the nitrogen oxide purification catalyst is higher than the second predetermined value.

The control portion may use an oxygen concentration difference between front side and rear side of the nitrogen oxide purification catalyst to detect the purification rate of the nitrogen oxide purification catalyst after the fuel is additionally injected by the injector, and varies the injection pattern of the injector in a case in which the oxygen concentration difference thereof is lower than a predetermined value.

A fuel cracking catalyst may be mounted at the exhaust line between the injector and the nitrogen oxide purification catalyst to transform the fuel that is additionally injected through the injector to a reducing agent and to raise temperature of a rear side thereof, and the reducing agent that is formed by the fuel cracking catalyst detaches the nitrogen oxide that is trapped in the nitrogen oxide purification catalyst and reduces the detached nitrogen oxide, wherein after it is determined that the fuel cracking catalyst is deteriorated, the control portion varies the injection pattern of the injector at the next injection and wherein the deterioration of the nitrogen oxide purification catalyst is concluded in a case that temperature difference between front side and rear side of the fuel cracking catalyst and/or temperature difference between front side and rear side of the nitrogen oxide purification catalyst are lower than a second predetermined value and a third predetermined value respectively and oxygen concentration difference between the front side and the rear side of the nitrogen oxide purification catalyst is higher than a fourth predetermined value.

The injection pattern may include injection amount of the fuel, injection cycle, injection time, and pulse width.

After it is determined that the nitrogen oxide purification catalyst is deteriorated, the control portion may vary the injection pattern of the injector at the next injection.

The injector may include a first injector that injects fuel into air for combustion in an engine or into a cylinder thereof, or a second injector that is disposed at the exhaust line to inject fuel.

In various aspects of the present invention, if it is determined that the deterioration rate of the nitrogen oxide purification catalyst or the fuel cracking catalyst is higher than a predetermined value, the fuel injection pattern is varied to effectively manage the deterioration rate of the catalyst at the next fuel injection.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of an exhaust system according to an exemplary embodiment of the present invention.

FIG. 2 is a flowchart of an exhaust system according to an exemplary embodiment of the present invention.

FIG. 3 is a schematic diagram of an exhaust system according to another exemplary embodiment of the present invention.

FIG. 4A and FIG. 4B are control flowcharts of an exhaust system according to another exemplary embodiment of the present invention.

FIG. 5 is a graph showing reducing agent injection amount and temperature difference between the front and rear of the catalyst in an exhaust system according to an exemplary embodiment of the present invention.

FIG. 6 is a graph showing a temperature difference between the front and rear of the catalyst according to travel distance in an exhaust system according to an exemplary embodiment of the present invention.

FIG. 7 is a schematic graph of a fuel injection pattern of an injector in an exhaust system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

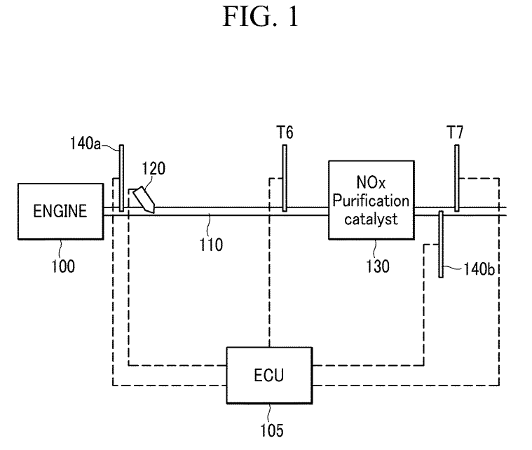

FIG. 1 is a schematic diagram of an exhaust system according to an exemplary embodiment of the present invention.

Referring to FIG. 1, an exhaust system includes an engine 100, an exhaust line 110, an injector 120, a nitrogen oxide purification catalyst 130, a first oxygen sensor 140a, a second oxygen sensor 140b, a first temperature sensor T6, a second temperature sensor T7, and a control portion 105.

The control portion 105 can be operated by at least one of microprocessors that are executed through a predetermined program, and the predetermined program includes a series of orders to perform each step according to an exemplary embodiment of the present invention that is to be mentioned.

The first oxygen sensor 140a, the injector 120, the first temperature sensor T6, the nitrogen oxide purification catalyst 130, the second oxygen sensor 140b, and the second temperature sensor T7 are sequentially disposed on the exhaust line 110.

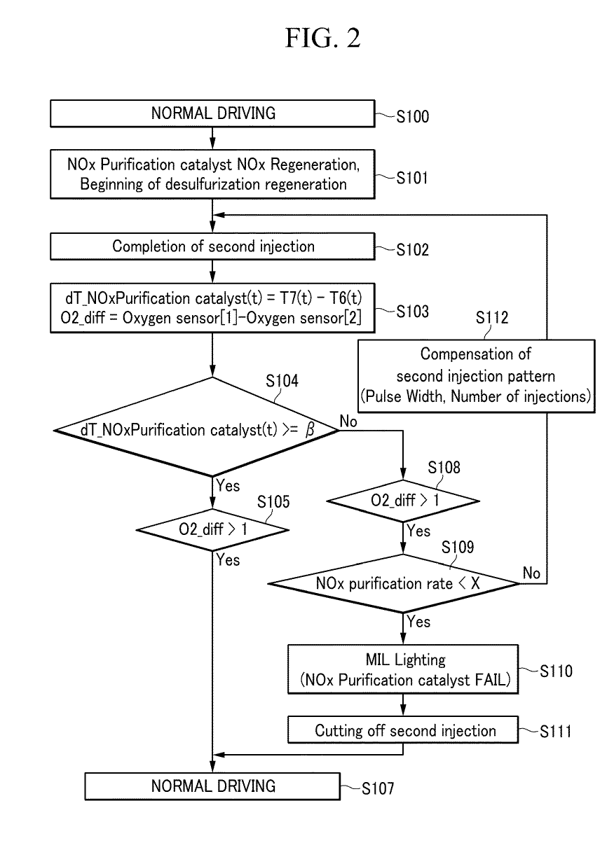

FIG. 2 is a flowchart of an exhaust system according to an exemplary embodiment of the present.

Referring to FIG. 2, the control method of the exhaust system performs a series of control operations that includes a zero step S100, a first step S101, a second step S102, a third step S103, a fourth step S104, a fifth step S105, a seventh step S107, an eighth step S108, a ninth step S109, a tenth step S110, an eleventh step S111, and a twelfth step S112.

In the present invention, a detailed description regarding a sixth step S106 is omitted.

In the zero step S100, the engine 100 is normally operated. The nitrogen oxide regeneration condition or the desulfurization condition is satisfied in the first step S101.

In the second step 5102, a reducing agent, that is, gasoline or diesel, is injected through the injector 120. The temperature difference between the front and rear of the nitrogen oxide purification catalyst 130 is detected in the third step S103, and the temperature is detected by the first temperature sensor T6 and the second temperature sensor T7 and the difference is calculated through a control portion (not shown).

If the temperature difference between the front and rear of the nitrogen oxide purification catalyst 130 is higher than a predetermined value in the fourth step S104, it is determined whether the oxygen concentration difference that is detected by the first oxygen sensor 140a and the second oxygen sensor 140b is higher than a predetermined value in the fifth step S105.

If the oxygen concentration difference is higher than a predetermined value in the fifth step S105, it is returned to normal driving in the seventh step S107.

If the temperature difference between the front and rear of the nitrogen oxide purification catalyst 130 is smaller than a predetermined value in the fourth step S104 of an exemplary embodiment of the present invention, it is determined whether the oxygen concentration difference that is detected by the first oxygen sensor 140a and the second oxygen sensor 140b is larger than a predetermined value in the eighth step S108.

If the oxygen concentration difference is larger than a predetermined value, it is determined whether the nitrogen oxide purification rate of the nitrogen oxide purification catalyst 130 is less than a predetermined value in the ninth step S109.

If the nitrogen oxide purification rate is less than a predetermined value, it is concluded that the nitrogen oxide purification catalyst 130 is not operated in the eleventh step S111 to light an emergency lamp, and the injector 120 does not inject the fuel.

If the purification rate of the nitrogen oxide purification catalyst 130 is larger than a predetermined value in the ninth step S109, that is, the nitrogen oxide purification catalyst 130 works to some degree, it is concluded that the nitrogen oxide purification catalyst 130 is deteriorated.

If it is concluded that the nitrogen oxide purification catalyst 130 is deteriorated in the ninth step S109, the injection pattern of the injector 120 is compensated in the twelfth step S112.

In an exemplary embodiment of the present invention, the injection pattern includes the number of injections, injection cycle, pulse width, injection amount, and so on.

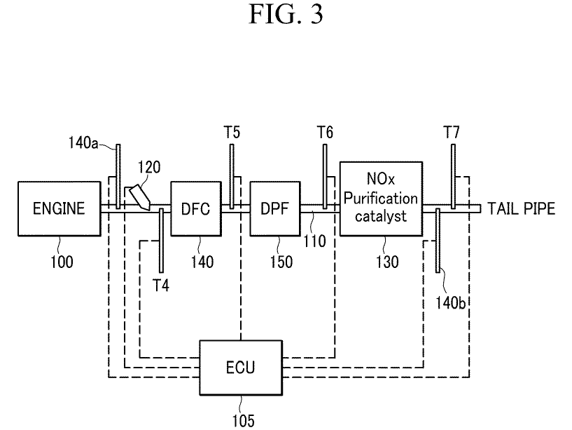

FIG. 3 is a schematic diagram of an exhaust system according to another exemplary embodiment of the present invention.

Referring to FIG. 3, an exhaust system includes an engine 100, an exhaust line 110, a first oxygen sensor 140a, an injector 120, a third temperature sensor T4, a fuel cracking catalyst 140, a fourth temperature sensor T5, a particulate filter 150, a first temperature sensor T6, a nitrogen oxide purification catalyst 130, a second oxygen sensor 140b, and a second temperature sensor T7.

In an exemplary embodiment of the present invention, a detailed description regarding common parts of FIG. 1 and FIG. 3 is omitted.

On the exhaust line 110, the first oxygen sensor 140a, the injector 120, the third temperature sensor T4, the fuel cracking catalyst 140, the fourth temperature sensor T5, the particulate filter 150, the first temperature sensor T6, the nitrogen oxide purification catalyst 130, the second oxygen sensor 140b, and the second temperature sensor T7 are sequentially disposed.

The fuel cracking catalyst can be called a diesel fuel cracking (DFC) catalyst that activates the diesel.

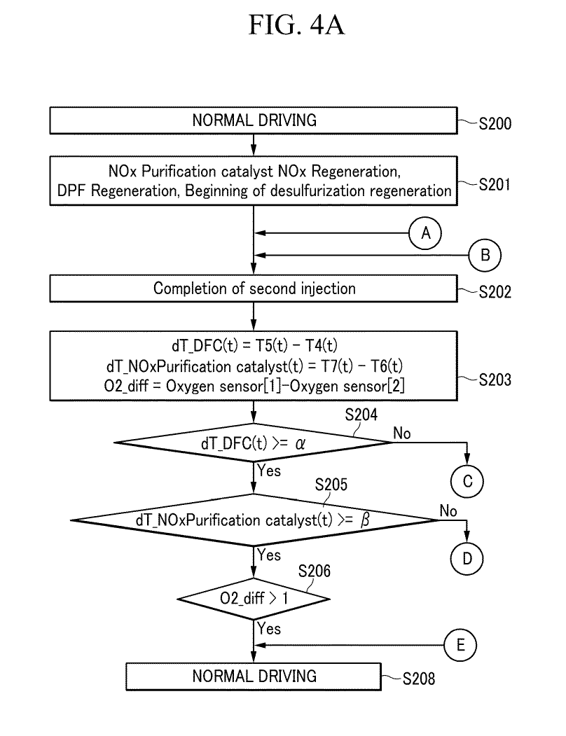

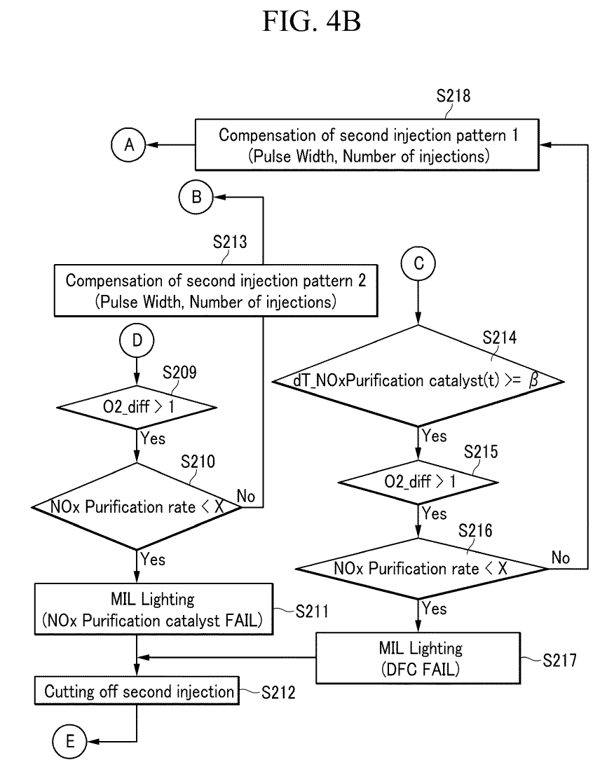

FIG. 4A and FIG. 4B are control flowcharts of an exhaust system according to another exemplary embodiment of the present invention.

Referring to FIG. 4A and FIG. 4B, the control method of the exhaust system performs a series of control steps that includes a zero step S200, a first step S201, a second step S202, a third step S203, a fourth step S204, a fifth step S205, a sixth step S206, an eighth step S208, a ninth step S209, a tenth step S210, an eleventh step S211, a twelfth step S212, a thirteenth step S213, a fourteenth step S214, a fifteenth step S215, a sixteenth step S216, a seventeenth step S217, and an eighteenth step S218.

In the present invention, a detailed description and drawing regarding a seventh step S207 is omitted.

The engine 100 normally operates in the zero step S200, and it is determined whether the regeneration condition or the desulfurization condition of the nitrogen oxide purification catalyst 130 is satisfied in the first step S201.

If the condition thereof is satisfied, the injector 120 injects a reducing agent, that is, fuel, in the second step S202.

If the fuel is injected through the injector 120, the temperature difference between the front side and the rear side of the fuel cracking catalyst 140 and the temperature difference between the front side and the rear side of the nitrogen oxide purification catalyst 130 are detected in the third step S203. Further, the oxygen concentration difference between the first oxygen sensor 140a and the second oxygen sensor 140b is detected in the third step S203.

If the temperature difference between the front side and the rear side of the fuel cracking catalyst 140 is larger than a predetermined value in the fourth step S204, it is determined whether the temperature difference of the front and rear of the nitrogen oxide purification catalyst 130 is larger than a predetermined value in the fifth step S205, and if the temperature difference thereof is larger than the value, it is determined whether the oxygen concentration difference between the first oxygen sensor 140a and the second oxygen sensor 140b is larger than a predetermined value in the sixth step S206.

If the temperature difference between the front and rear of the fuel cracking catalyst 140, the temperature difference between the front and rear of the nitrogen oxide purification catalyst 130, and the oxygen concentration difference between the first oxygen sensor 140a and the second oxygen sensor 140b are larger than a predetermined value in the fourth step S204, the fifth step S205, and the sixth step S206, it is determined that the fuel cracking catalyst 140 and the nitrogen oxide purification catalyst 130 are not deteriorated.

If it is determined that the fuel cracking catalyst 140 and the nitrogen oxide purification catalyst 130 are not deteriorated, the engine 100 is normally operated in the eighth step S208.

If the temperature difference between the front and rear of the fuel cracking catalyst 140 is less than a predetermined value in the fourth step S204, the fourteenth step S214, the fifteenth step S215, and the sixteenth step S216 are executed.

If the temperature difference between the front and rear of the nitrogen oxide purification catalyst 130 is larger than a predetermined value in the fourteenth step S214, and if the oxygen concentration difference between the first oxygen sensor and the second oxygen sensor 140b is larger than a predetermined value in the fifteenth step S215, it is determined whether the nitrogen oxide purification rate of the nitrogen oxide purification catalyst 130 is less than a predetermined value in the sixteenth step S216.

In an exemplary embodiment of the present invention, the method for calculating the purification rate of the nitrogen oxide purification catalyst 130 is well known in the related art, so a detailed description thereof will be omitted.

Therefore, it is determined whether the deteriorated nitrogen oxide purification catalyst 130 works to some degree in the sixteenth step S216.

If the purification rate of the nitrogen oxide purification catalyst 130 is less than a predetermined minimum value in the sixteenth step S216, it is concluded that the fuel cracking catalyst 140 does not work and an emergency lamp is lit in the seventeenth step S217.

Further, if it is determined that the nitrogen oxide purification catalyst 130 has a predetermined purification rate in the sixteenth step S216, the injection pattern of the injector 120 is varied in the eighteenth step S218. The injection pattern includes the number of injections, injection cycle, pulse width, and injection amount in an exemplary embodiment of the present invention.

The ninth step S209, the tenth step S210, the eleventh step S211, and the twelfth step S212 in FIG. 4a and FIG. 4B are respectively the same as the eighth step S108, the ninth step S109, the tenth step S110, and the eleventh step S111 in FIG. 2, so detailed descriptions thereof are omitted.

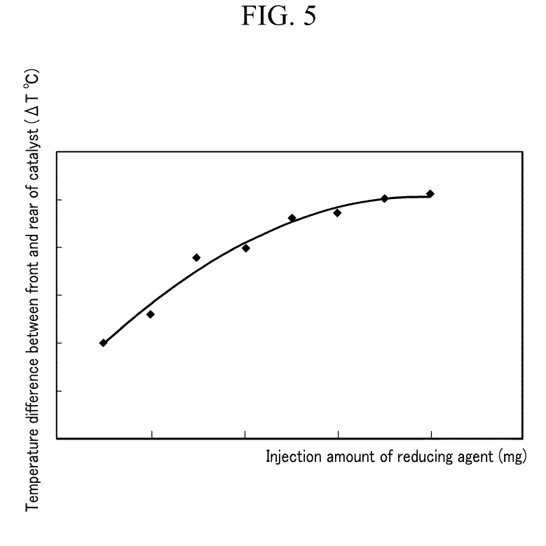

FIG. 5 is a graph showing reducing agent injection amount and temperature difference between the front and rear of the catalyst in an exhaust system according to an exemplary embodiment of the present invention.

Referring to FIG. 5, the greater the amount of the reducing agent, that is, fuel, that is injected by the injector 120, the greater the temperature difference of the front and rear of the nitrogen oxide purification catalyst 130 or the fuel cracking catalyst 140 is. The reason is that the injected fuel is burned to be oxidized by catalyst elements of the nitrogen oxide purification catalyst 130 or the fuel cracking catalyst 140 such that the high temperature exhaust gas is supplied to the rear side thereof.

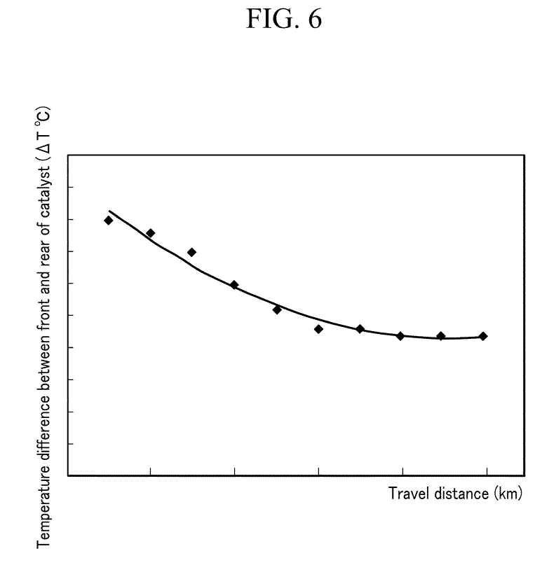

FIG. 6 is a graph showing a temperature difference between the front and the rear of the catalyst according to travel distance in an exhaust system according to an exemplary embodiment of the present invention.

Referring to FIG. 6, the longer the operating time of the engine 100, that is, the travel distance of a vehicle, if predetermined conditions are identical, the smaller the temperature difference of the front and rear of the nitrogen oxide purification catalyst 130 or the fuel cracking catalyst 140 is.

That is, as the travel distance becomes longer, the catalyst components of the nitrogen oxide purification catalyst 130 or the fuel cracking catalyst 140 are deteriorated such that the performance thereof becomes low.

Accordingly, when the fuel is injected through the injector 120 such that the injected fuel passes the catalyst, the oxidation rate thereof is low such that the temperature of the exhaust gas is relatively low compared to the normal catalyst.

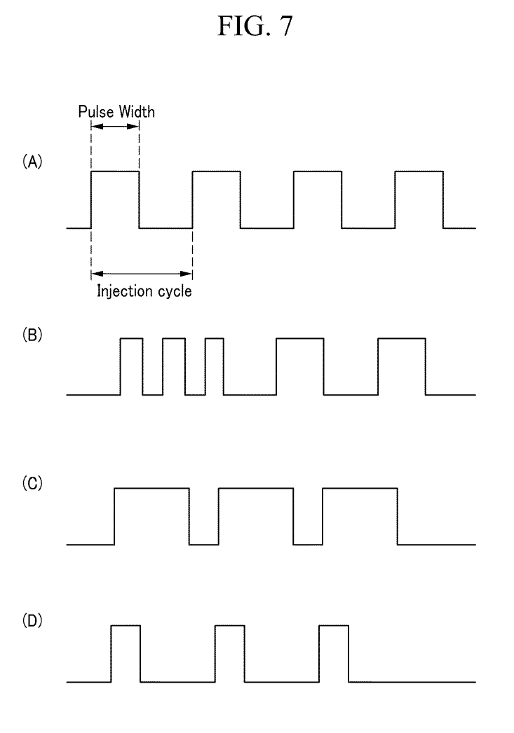

FIG. 7 is a schematic graph of a fuel injection pattern of an injector in an exhaust system according to an exemplary embodiment of the present invention.

Referring to FIG. 7, a plurality of exemplary embodiments of the injection patterns that are injected by the injector 120 are shown.

In (A), the horizontal axis signifies time, and the peak section signifies the injection period during which the fuel is substantially injected by the injector 120. As the injection cycle is shorter, the injection amount is smaller. Further, as the pulse width becomes longer, the injection amount is larger.

As described above, the injection pattern can be varied as shown in (B), (C), and (D) by changing the injection cycle and the pulse width. Further, the entire injection cycle and the entire injection time can be varied.

Referring to FIG. 1 and FIG. 3, the nitrogen oxide purification catalyst 130 traps the nitrogen oxide (NOx) that is included in the exhaust gas of the engine 100, and the reducing agent that is transformed by the fuel cracking catalyst 140 detaches the trapped nitrogen oxide to reduce it.

That is, so as to detach and reduce the nitrogen oxide that is absorbed in the nitrogen oxide purification catalyst 130, the injector 120 that is mounted on the exhaust line 110 injects the fuel, and the fuel cracking catalyst 140 makes reducing agent such as HC, CO, H2, and so on. The nitrogen oxide purification catalyst uses the reducing agent to be regenerated thereby.

As described above, in an exemplary embodiment of the present invention, the fuel that is injected by the injector 120 of the exhaust line is transformed to the reducing agent by the fuel cracking catalyst, and if a predetermined condition is satisfied, the fuel injection pattern of the injector 120 is varied.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust system, comprising:
an exhaust line through which exhaust gas passes;
a nitrogen oxide purification catalyst that is mounted on the exhaust line to reduce nitrogen oxide of the exhaust gas;
an injector that is mounted at an upstream side of the nitrogen oxide purification catalyst to additionally inject fuel such that nitrogen oxide that is trapped in the nitrogen oxide purification catalyst is detached to be reduced thereby; and
a control portion that varies an injection pattern of the injector if it is determined that a purification rate of the nitrogen oxide purification catalyst is higher than a first predetermined value.

2. The exhaust system of claim 1, wherein the control portion uses a temperature difference between front side and rear side of the nitrogen oxide purification catalyst to detect the purification rate of the nitrogen oxide purification catalyst after the fuel is additionally injected by the injector, and varies the injection pattern of the injector in a case in which the temperature difference thereof is lower than a second predetermined value.

3. The exhaust system of claim 2, wherein the control portion uses an oxygen concentration difference between the front side and the rear side of the nitrogen oxide purification catalyst to detect the purification rate of the nitrogen oxide purification catalyst after the fuel is additionally injected by the injector, and varies the injection pattern of the injector in a case in which the oxygen concentration difference thereof is higher than a third predetermined value.

4. The exhaust system of claim 3, wherein after it is determined that the nitrogen oxide purification catalyst is deteriorated, the control portion varies the injection pattern of the injector at the next injection and wherein the deterioration of the nitrogen oxide purification catalyst is concluded in a case that the temperature difference between the front side and the rear side of the nitrogen oxide purification catalyst is lower than the second predetermined value and the oxygen concentration difference between the front side and the rear side of the nitrogen oxide purification catalyst is higher than the second predetermined value.

5. The exhaust system of claim 1, wherein the control portion uses an oxygen concentration difference between front side and rear side of the nitrogen oxide purification catalyst to detect the purification rate of the nitrogen oxide purification catalyst after the fuel is additionally injected by the injector, and varies the injection pattern of the injector in a case in which the oxygen concentration difference thereof is lower than a predetermined value.

6. The exhaust system of claim 1, wherein a fuel cracking catalyst is mounted at the exhaust line between the injector and the nitrogen oxide purification catalyst to transform the fuel that is additionally injected through the injector to a reducing agent and to raise temperature of a rear side thereof, and
the reducing agent that is formed by the fuel cracking catalyst detaches the nitrogen oxide that is trapped in the nitrogen oxide purification catalyst and reduces the detached nitrogen oxide.

7. The exhaust system of claim 6, wherein after it is determined that the fuel cracking catalyst is deteriorated, the control portion varies the injection pattern of the injector at the next injection and wherein the deterioration of the nitrogen oxide purification catalyst is concluded in a case that temperature difference between front side and rear side of the fuel cracking catalyst and/or temperature difference between front side and rear side of the nitrogen oxide purification catalyst are lower than a second predetermined value and a third predetermined value respectively and oxygen concentration difference between the front side and the rear side of the nitrogen oxide purification catalyst is higher than a fourth predetermined value.

8. The exhaust system of claim 1, wherein the injection pattern includes injection amount of the fuel, injection cycle, injection time, and pulse width.

9. The exhaust system of claim 1, wherein after it is determined that the nitrogen oxide purification catalyst is deteriorated, the control portion varies the injection pattern of the injector at the next injection.

10. The exhaust system of claim 1, wherein the injector includes:
a first injector that injects fuel into air for combustion in an engine or into a cylinder thereof; or
a second injector that is disposed at the exhaust line to inject fuel.
